(19) United States
(12) Patent Application Publication
(10) Pub. No.: US 2026/0288897 A1
(43) Pub. Date: Sep. 24, 2026

(54) TWO-DIMENSIONAL VECTOR MASKING FOR IMPROVING THE PERFORMANCE OF MATRIX MULTIPLICATION

(71) Applicant: Hewlett Packard Enterprise Development LP, Spring, TX (US)

(72) Inventor: Aaron Matthew Collier, Woodbury, MN (US)

(21) Appl. No.: 19/088,697

(22) Filed: Mar. 24, 2025

(51) Int. Cl. G06F 17/16; G06F 5/01

(52) U.S. Cl. CPC G06F 17/16; G06F 5/01

(57) ABSTRACT

A processor may receive a request for performing a matrix-multiplication operation between first matrix and second matrices, determine a vector length of registers provided by the processor, and perform the matrix-multiplication operation to obtain a third matrix. The matrix-multiplication operation may include a number of iterations, each of which comprising: determining a number of remainder rows based on a total number of rows in the first matrix and the vector length; determining a number of remainder columns based on a total number of columns in the second matrix and the vector length; creating a first mask based on the number of remainder rows; creating a second mask based on the number of remainder columns; and transferring, from a memory associated with the processor to the registers, data associated with the first and second matrices based on the first and second masks, respectively.

### FIELD

This disclosure relates to the optimization of computer performance. More specifically, this disclosure relates to performance improvement of matrix-multiplication operations in computer systems.

### RELATED ART

Matrix multiplication is a cornerstone operation for numerous high-performance computing (HPC) workloads, encompassing both traditional applications such as Car-Parrinello code for the new Millenium (CP2K) and Vienna Ab initio Simulation Package (VASP), as well as contemporary machine learning (ML) and deep learning (DL) tasks. The performance of matrix multiplication directly affects the training and inference times of many ML/DL models, particularly in the realm of deep neural networks. As such, enhancing the computational efficiency of matrix multiplication is paramount for the scalability of ML/DL models, allowing them to process larger datasets and accommodate increasingly complex architectures.

The typical algorithm for multiplying two n×n matrices exhibits a time complexity of O(n³), rendering matrix multiplication a computationally demanding operation, particularly for large matrices. One optimization approach is based on Single-Instruction, Multiple-Data (SIMD) instructions, which facilitates the vectorization of matrix-multiplication operations. This vectorization allows the resulting matrix to be partitioned into sub-blocks or tiles, which makes parallel processing possible. However, the resulting matrix may have arbitrary dimensions that are not divisible by the tiles.

### BRIEF DESCRIPTION OF THE FIGURES

FIG. 1A illustrates an example register-blocking approach for matrix multiplication, according to one aspect of the instant disclosure.

FIG. 1B illustrates an example register-blocking scenario with partially filled registers, according to one aspect of the instant disclosure.

FIG. 2 illustrates a table comparing the number of conditional checks required by the conventional tiling technique without masking to the number of conditional checks required by the register masking technique, according to one aspect of the instant disclosure.

FIG. 3 illustrates a table comparing the number of conditional checks required by the conventional tiling technique without masking to the number of conditional checks required by the register masking technique, according to one aspect of the instant disclosure.

FIG. 4A presents a flowchart illustrating an example process for performing a matrix-multiplication operation, according to one aspect of the instant disclosure.

FIG. 4B presents a flowchart illustrating example operations within each iteration, according to one aspect of the instant disclosure.

FIG. 5 illustrates the measured relative performance improvement of the register masking scheme over the conventional scheme without register masking, according to one aspect of the instant disclosure.

FIG. 6 illustrates an example computer system facilitating matrix multiplication with register masking, according to one aspect of the instant disclosure.

FIG. 7 illustrates a computer-readable medium (CRM) that facilitates matrix multiplication with register masking, according to one aspect of the instant disclosure.

In the figures, like reference numerals refer to the same figure elements.

### DETAILED DESCRIPTION

Matrix multiplication is a fundamental operation in linear algebra that combines two matrices to produce a new matrix. This process involves multiplying rows of the first matrix, known as the multiplier matrix, by columns of the second matrix, referred to as the multiplicand matrix. The resulting matrix, referred to as the product matrix, encapsulates the combined information from both input matrices, making this operation crucial in various fields such as computer graphics, data analysis, and machine learning. An example matrix-multiplication operation may be defined as C=AB, where the dimensions of matrices A, B, and C are m×k, k×n, and m×n, respectively. Each element of the product matrix C, denoted cᵢⱼ, is the dot product of the ith row of the multiplier matrix A and the jth column of the multiplicand matrix B.

A standard implementation of matrix multiplication typically employs nested loops that iterate over the three dimensions of matrices A, B, and C. These dimensions are often referred to as the m-, n-, and k-dimensions. The m- and n-dimension may also be referred to as the row- and column-dimension, respectively, because they correspond to the rows and columns in the product matrix. The order of the nested loops may be determined based on the data-access pattern. For example, when an m/n/k ordering may be chosen, the nested loops may include an outermost loop x(1:m), an intermediate loop y(1:n), and an inner most loop z(1:k,Δk), where x, y, and z are iterators, and the term Δk denotes the number of iterations used for loop unrolling, a technique employed to enhance performance by reducing loop overhead and improving instruction-level parallelism.

SIMD instructions significantly enhance the computation efficiency of matrix operations, including matrix multiplication, by allowing parallelization. SIMD processors feature wider registers, often called vector registers, capable of holding multiple data elements simultaneously. The key advantage of SIMD is that a single instruction can be applied to all elements in a vector register concurrently, allowing for the vectorization of matrix-multiplication operations. This parallelism substantially increases processing speed and efficiency.

An aforementioned matrix-multiplication operation in the form of C=AB may be expanded as:

$$( \begin{matrix}{a}_{11} & {a}_{12} & … & {a}_{1 k} \\ {a}_{21} & {a}_{22} & … & {a}_{2 k} \\ ⋮ & ⋮ & ⋱ & ⋮ \\ {a}_{m 1} & {a}_{m 2} & … & {a}_{mk}\end{matrix} ) ( \begin{matrix}{b}_{11} & {b}_{12} & … & {b}_{1 k} \\ {b}_{21} & {b}_{22} & … & {b}_{2 k} \\ ⋮ & ⋮ & ⋱ & ⋮ \\ {b}_{k 1} & {a}_{k 2} & … & {a}_{kn}\end{matrix} ) = ( \begin{matrix}{c}_{11} & {c}_{12} & … & {c}_{1 n} \\ {c}_{21} & {c}_{22} & … & {c}_{2 n} \\ ⋮ & ⋮ & ⋱ & ⋮ \\ {c}_{m 1} & {a}_{m 2} & … & {c}_{mn}\end{matrix} ) ,$$

where

$${c}_{ij} = {\sum }_{p = 1}^{k} {a}_{ip} * {b}_{pj}$$

for i=1, . . . , m and j=1, . . . , n. A matrix can be stored in local memory using two primary methods: row-major order or column-major order. In row-major order, the elements of each row are stored contiguously, creating a sequential arrangement of rows. Conversely, column-major order stores the elements of each column contiguously, resulting in a sequential arrangement of columns

Using the column-major order as an example, each column of a matrix (e.g., matrix A) may be stored in a contiguous block of memory, which may also include extra unused data, causing the matrix in the memory to have extra rows. In one example, one may define a variable t as the stride between the first elements of consecutive columns (e.g., a₁₁ and a₁₂). For a matrix A with dimensions of m×k, the memory addresses of the first elements of consecutive columns may abide: address of a₁₍ₖ₊₁₎=address of a₁ₖ+t, where k=1, . . . , k−1 and t≥m.

Matrix multiplication implementations must handle four combinations of transposed (T) and non-transposed (N) input matrices: NN, TN, NT, and TT. While the mathematical result remains consistent across these combinations, the data-access patterns and cache efficiency vary significantly. NN stands for non-transposed access to both matrices; TN stands for transposed access to matrix A and non-transposed access to matrix B; NT stands for non-transposed access to matrix A and transposed access to matrix B; and TT stands for non-transposed access to both matrices.

Assuming m/n/k loop ordering, multiplication of a m×k (N) or k×m (T) matrix A and a k×n (N) or n×k (T) matrix B can include multiplying m elements of matrix A with n elements of matrix B because we are multiplying an m×1 vector by an 1×n vector, resulting in an m×n matrix (i.e., matrix C), expressed as:

$$( \begin{matrix}{a}_{1 p} \\ ⋮ \\ {a}_{mp}\end{matrix} ) ( \begin{matrix}{b}_{p 1} & … & {b}_{pn}\end{matrix} ) = ( \begin{matrix}{a}_{1 p} * {b}_{p 1} & … & {a}_{1 p} * {b}_{pn} \\ ⋮ & ⋱ & ⋮ \\ {a}_{mp} * {b}_{p 1} & … & {a}_{mp} * {b}_{pn}\end{matrix} ) ,$$

iterating over p=1, . . . , k. In other words, the m×n matrix is updated a total of k times in the innermost loop. The above mathematical representation is input agnostic, and the N/T orientation of the input matrices A and B only affects the algorithmic implementation of data loading, without affecting the mathematical outcome.

To further optimize the performance of matrix-multiplication operations, register blocking or tiling techniques may be employed, which can reduce the number of iterations, thereby improving overall efficiency. In this approach, the resulting product matrix (matrix C) is divided into sub-blocks or tiles that fit within the processor's registers. The size of these sub-blocks or tiles is determined by two main factors: the vector length of each register (i.e., the number of matrix elements a single register can hold) and the total number of available registers. Moreover, the arrangement of the registers (e.g., row-wise or column-wise) may define the way the product matrix C is partitioned. The strategic partitioning of the product matrix allows for more efficient use of the processor's resources, particularly in terms of cache utilization and register management.

Register blocking may be applied to matrices of any size (where m, n, and k may have arbitrary values) and is particularly beneficial to small matrices, which are prevalent in machine learning (ML) and deep learning (DL) workflows. For small matrices, loop management (e.g., index calculations and branch predictions) consumes a disproportionate fraction of execution time. Moreover, resource utilization has a more significant impact on small matrices. In ML/DL applications, transformers and recurrent networks involve batched small matrix multiplications (e.g., attention heads and token embeddings), and matrix multiplication optimization is critical for latency-sensitive training. The logical complexity of matrix multiplication algorithms can significantly affect ML/DL training performance due to potential branch mispredictions leading to pipeline stalls. Furthermore, conditional checks, such as if-else statements, introduce additional execution overhead.

In one simple example, we may assume m and n are multiples of the register vector length (denoted l). The multiplication between an l×1 vector and a 1×l vector results in an l×l sub-block, expressed as:

$$( \begin{matrix}{a}_{ip} \\ ⋮ \\ {a}_{( i + l - 1 ) p}\end{matrix} ) ( \begin{matrix}{b}_{pj} & … & {b}_{p ( j + l - 1 )}\end{matrix} ) = ( \begin{matrix}{a}_{ip} * {b}_{pj} & … & {a}_{ip} * {b}_{p ( j + l - 1 )} \\ ⋮ & ⋱ & ⋮ \\ {a}_{( i + l - 1 ) p} * {b}_{pj} & … & {a}_{( i + l - 1 ) p} * {b}_{p ( j + l - 1 )}\end{matrix} ) .$$

Sub-blocks in the product matrix C may be computed for i=1, . . . , m and j=1, . . . , n with steps of size l and iterated over p=1, . . . , k. In other words, multiplication of the input matrices (i.e., matrix A and matrix B) may be performed by updating each l×l sub-block of the m×n product matrix (i.e., matrix C) a total of k times.

According to some aspects, transforming the above mathematical expression regarding the l×l sub-block in matrix C into a vectorized kernel may start with multiplying an l×1 vector by a scalar, resulting in an l×1 vector:

$$( \begin{matrix}{a}_{ip} \\ ⋮ \\ {a}_{( i + l - 1 ) p}\end{matrix} ) ( {b}_{pj} ) = ( \begin{matrix}{a}_{ip} * {b}_{pj} \\ ⋮ \\ {a}_{( i + l - 1 ) p} * {b}_{pj}\end{matrix} ) ,$$

followed by repeating this operating over all columns: j=1, . . . , l. The l×l sub-block may then be updated k times for p=1, . . . , k. Applying this definition to vector registers, one may multiply a vector containing/consecutive elements of matrix A by a vector containing a broadcast value of matrix B, expressed in the form of vector multiplication as:

$$[ {a}_{ip} , … , {a}_{( i + l - 1 ) p} ] * [ {b}_{pj} , … , {b}_{pj} ] = [ {a}_{ip} * {b}_{pj} , … , {a}_{( i + l - 1 ) p} {b}_{pj} ] = [ {c}_{ij} , … , {c}_{( i + l - 1 ) j} ] .$$

The above vector operation is valid for all N/T orientations of matrices A and B. Data can be preprocessed if needed. Regarding the access pattern of the input matrices stored in the memory, there are a total of four cases to be considered, including non-transposed multiplier matrix A (in the form of a m×k matrix), transposed multiplier matrix A (in the form of an k×m matrix), non-transposed multiplicand matrix B (in the form of a k×n matrix), and transposed multiplicand matrix B (in the form of an n×k matrix). More specifically, access to the non-transposed matrix A involves loading m contiguous elements from column k, whereas access to the transposed matrix A involves gathering m non-contiguous elements from row k. On the other hand, access to the non-transposed matrix B involves gathering n non-contiguous elements from row k, whereas access to the transposed matrix B involves loading n contiguous elements from column k. Among the above four cases, only the transposed matrix A and non-transposed matrix B require extra processing (e.g., gathering of the scattered matrix elements).

For simplicity of discussion, consider a scenario where m=n=l, in which the multiplication of matrices A and B results in a product matrix C with dimensions l×l. For a non-transposed matrix A or a transposed matrix B, column elements of each matrix may be stored contiguously in the memory. During matrix multiplication, l contiguous elements from column k of a corresponding matrix may be transferred into a vector register. On the other hand, for a transposed matrix A or a non-transposed matrix B, row elements of each matrix may be strided and t units apart. During matrix multiplication, l non-contiguous elements from row k of a corresponding matrix may be transferred into a vector register. A standard load instruction may be used to transfer contiguous elements into the vector register, whereas transferring non-contiguous elements may require intermediate steps (e.g., by using gather instructions).

For larger input matrices with dimensions m and n that are multiples of l, the pseudocode for transferring data from the non-transposed matrix A may be expressed as: load {aᵢₖ, . . . , a₍ᵢ₊ₗ₋₁₎ₖ}→v_{A}[a₁, . . . , aₗ], and the pseudocode for transferring data from the transposed matrix A may be expressed as: gather {aₖᵢ, . . . , a₍ₖ₊ₗ₋₁₎ᵢ:t}>v_{A}[a₁, . . . , aₗ]. On the other hand, the pseudocode for transferring data from the non-transposed matrix B may be expressed as: gather {bₖⱼ, . . . , bₖ₍ⱼ₊ₗ₋₁₎}→v₁[b₁, . . . , bₗ]; broadcast v₁[b₁, . . . , bₗ]→v_{B}[b_{λ}, . . . , b_{λ}] for λ=1, . . . , l. The pseudocode for transferring data from the transposed matrix B may be expressed as: load {bⱼₖ, . . . , b₍ⱼ₊ₗ₋₁₎ₖ}→v₁[b₁, . . . , bₗ]; broadcast v₁[b₁, . . . , bₗ]→v_{B}[b_{λ}, . . . , b_{λ}] for λ=1, . . . , l. Note that v_{A} and v_{B} are registers containing data from matrices A and B, respectively, that are necessary to compute the column-major updates of the l×l sub-block of product matrix C. A load instruction copies contiguous data from a specified memory location into a vector register, a gather instruction copies non-contiguous data (e.g., data with a strided access pattern) from a specified memory location into a vector register, and a broadcast instruction replicates data to all elements within a vector register. Broadcasting one element from matrix B into the entire vector register is equivalent to multiplying an l×1 vector (i.e., a column from matrix A) by a scalar (i.e., an element from matrix B).

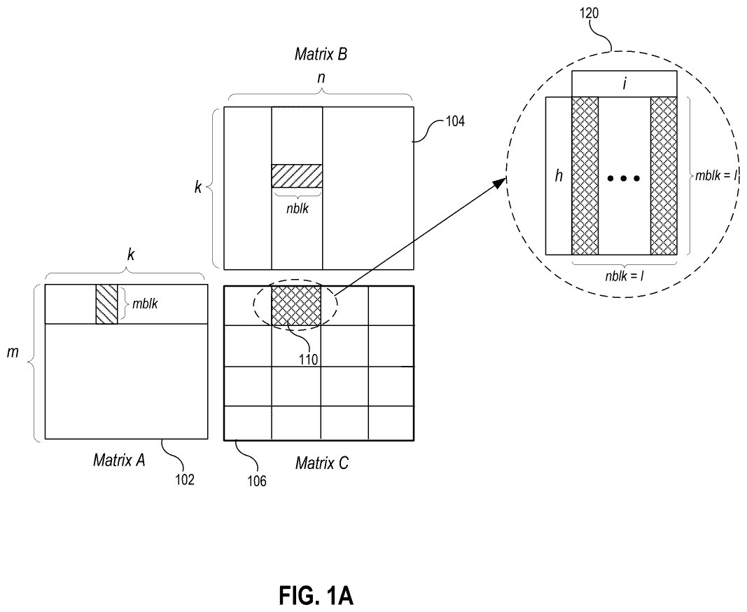

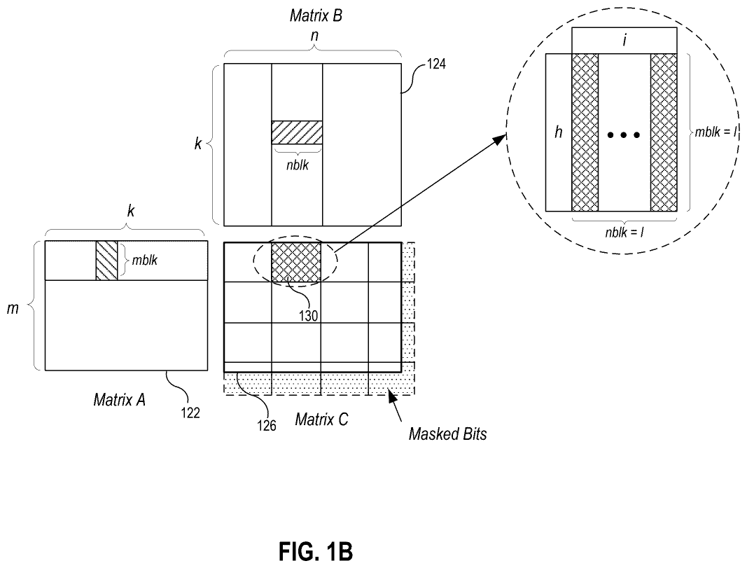

FIG. 1A illustrates an example register-blocking approach for matrix multiplication, according to one aspect of the instant disclosure. In FIG. 1A, a matrix 102 (matrix A) with a dimension m×k is multiplying a matrix 104 (matrix B) with a dimension k×n to generate a product matrix 106 (matrix C), which is divided into sub-blocks or tiles, including a tile 110. Each tile (e.g., tile 110) may be computed by loading required elements from matrices A and B, stepping through the k dimension. Tile 110 may have a dimension of mblk×nblk, where mblk corresponds to the number of rows of matrix elements held in the tile, and nblk corresponds to the number of columns.

In the example shown in FIG. 1A, m and n are multiples of !, and mblk=nblk=l. FIG. 1A also illustrates an example of the arrangement of the registers in tile 110, as shown in an amplified view 120 of tile 110. When expressed using registers, tile 110 has a size of h×i, where h is the number of registers in the row-dimension (also referred to as the m-dimension), and i is the number of registers in the column-dimension (also referred to as the n-dimension). Considering that each register may hold/matrix elements, dimensions of tile 110 may also be expressed using the number of matrix elements as h*l×i. In this example, h=1 and i=l.

As discussed previously, the multiplication between matrices A and B may involve stepping the register tile in the column- and row-dimensions until the entire matrix C is traversed. The example pseudocode for performing the matrix multiplication is shown below:

```
for i = 1,...,m : l
  for j = 1,..., n : l
    for p = 1,..., k
      Load l rows of A
      (N) load {aᵢₚ,...,a₍ᵢ₊ₗ₋₁₎ₚ} → v_{A} [a₁,...,aₗ] (column p) or
      (T) gather {aₚᵢ,...,a₍ₚ₊ₗ₋₁₎ᵢ : t} → v_{A} [a₁,...,aₗ] (row p)
      Load l columns of B
      (N) gather {bₚⱼ,...,bₚ₍ⱼ₊ₗ₋₁₎} → v₁ [b₁,...,bₗ] (row p) or
      (T) load {bⱼₚ,...,b₍ⱼ₊ₗ₋₁₎ₚ} → v₁ [b₁,...,bₗ] (column p)
      broadcast v₁ [b₁,...,bₗ] → v_{B} [bⱼ,...,bⱼ]
      v_{C} = v_{C} + v_{A} * v_{B}
    update C
    store v_{c} [c₁,...,cₗ] → {cᵢⱼ,...,c₍ᵢ₊ₗ₋₁₎ⱼ}
```

Depending on the layout of the input matrices in the memory, either the load or gather instruction will be used to transfer matrix elements from the memory to the registers. The store instruction in the last line copies data from register v_{C} to a specified memory location.

Considering that in practice the input matrices (i.e., matrices A and B) may have arbitrary dimensions, m and n may not be multiples of l. As a result, stepping the register tiles over the columns and/or rows of the product matrix C may result in partially filled vector registers. FIG. 1B illustrates an example register-blocking scenario with partially filled registers, according to one aspect of the instant disclosure.

In FIG. 1B, a matrix 122 (matrix A) with dimensions m×k is multiplying a matrix 124 (matrix B) with dimensions k×n to generate a product matrix 126 (matrix C). Similar to the example shown in FIG. 1A, product matrix 126 is divided into sub-blocks or tiles, such as a tile 130, with dimensions mblk×nblk, where mblk=nblk=1. In this example, m and n are not multiples of vector length l. Therefore, as the register tile steps through the column- and row-dimensions to the edges, some registers may be partially filled or filled with data not belonging to matrices A, B, and C.

In conventional approaches, vector operations on partially filled vector registers may include reducing the tile size at the edges, which may involve checking a number of extra cases. An extra case refers to applying a smaller tile to transfer the remainder rows or columns from memory into a vector register. To ensure that all possible cases regarding the number of bits in the partially filled register are covered, the algorithm needs to check extra cases where the tile dimensions are powers of 2 and are less than/in descending order. This is a requirement for any implementation that the extra cases be powers of 2, a consequence of using a binary system of representation in processors. For simplicity of discussion without losing generality, one may assume m<l and n<l. A complete list of the extra cases may include tile sizes in the following set: {l, 2^{μ}, . . . , 2⁰}, where μ=floor(log₂(l)). Note that/is included in the list only if it is not a power of 2.

The to-be-checked extra cases may differ in the row- and column-dimensions. In the example shown in FIG. 1B, we may assume the maximum row and column numbers equal the vector length, i.e., mₘₐₓ=l and nₘₐₓ=l. Therefore, the to-be-checked cases in the row-dimension may be defined as {mₘₐₓ, 2^{μ}, . . . , 2⁰}, where μ=floor(log₂(mₘₐₓ)). mₘₐₓ is included in the list only if it is not a power of 2. Similarly, the cases in the column-dimension may be defined as {nₘₐₓ, 2_{μ}, . . . , 2₀}, where μμ=floor(log₂(nₘₐₓ)). nₘₐₓ is included in the list only if it is not a power of 2. If mₘₐₓ or nₘₐₓ is a power of 2, the total number of to-be-checked cases (ω) may be ω=μ+1; if mₘₐₓ or nₘₐₓ is not a power of 2, the total number of to-be-checked cases (ω) may be ω=(μ+1)+1. In some examples, vector registers in the processor may have a vector length of eight. In such cases, the matrix-multiplication operation may need to check extra cases 4, 2, and 1 in both the row- and column-dimensions. These checks may require executing if-else statements in nested loops, including the m-, n-, and k-loops, which may negatively impact the matrix multiplication performance.

To improve performance (e.g., by reducing the code complexity and overhead associated with the extra cases), according to some aspects, a two-dimensional (2D) vector register masking scheme may be used to transfer matrix data from memory to registers. Register masking allows selective modification or reading of specific bits within a register while leaving others unchanged. According to some aspects, a mask may include a binary pattern used to isolate or modify specific bits, and applying the mask may involve using bitwise operations (e.g., AND, OR, XOR) with the mask and the register value. For example, if a particular bit in the mask is set as zero, and the mask is applied using the AND operation, then that particular bit would be read as zero by the processor.

Assuming that mₘₐₓ≤l and nₘₐₓ≤l, or mₘₐₓ mod l=0 and nₘₐₓ mod l=0, and that (mₘₐₓ−mblk)≤l and (nₘₐₓ−nblk)≤l, the example pseudocode for creating a register mask in the row- or column-dimension is shown below:

```
//Step 1: initialize the mask to all 1's
  set mask = [1,...,1]
//Step 2: Compute remainders
  set x = mₘₐₓ mod mblk or
  set x = nₘₐₓ mod nblk
//Step 3: Shift the mask right by l − x positions with zero fill to disable unused
data lanes
  shift mask □ l − x.
```

The generated mask may be applied to vector instructions (e.g., the load or gather instructions). For example, an AND operation between the transferred data and the mask can force specific bits in the register to zero. This way, the data transfer operation effectively ignores the extra data lanes in the current register tile. In FIG. 1B, the masked bits (represented by the shaded area) would be ignored when updating matrix C as they are all zeros.

Assuming m/n/k loop ordering, the pseudocode for implementing register masking to update a sub-block in the product matrix C is shown below:

```
set mₘₐₓ = l
set nₘₐₓ = l
for i = 1,...,m : l
  set mblk = min(m − (i − 1),l)
  create maskₘ
  for j = 1,..., n : l
    set nblk = min(n − (j − 1),l)
    create maskₙ
    for p = 1,..., k
      Load l rows of A
      (N) load {aᵢₚ,...,a₍ᵢ₊ₗ₋₁₎ₚ} → v_{A} [a₁,...,aₗ] & maskₘ (column p) or
      (T) gather {aₚᵢ,...,a₍ₚ₊ₗ₋₁₎ᵢ : t} → v_{A} [a₁,...aₗ] & maskₘ (row p)
      Load l columns of B
      (N) gather {bₚⱼ,...bₚ₍ⱼ₊ₗ₋₁₎} → v₁ [b₁,...,bₗ] & maskₙ (row p) or
      (T) load {bⱼₚ,...,b₍ⱼ₊ₗ₋₁₎ₚ} → v₁ [b₁,...,bₗ] & maskₙ (column p)
      broadcast v₁ [b₁,...,bₗ] → v_{B} [bⱼ,...,bⱼ]
      v_{C} = v_{C} + v_{A} * v_{B}
    update C
    store v_{c} [c₁,...,cₗ] & maskₘ → {cᵢⱼ,...,c₍ᵢ₊ₗ₋₁₎ⱼ}.
```

The first two lines of the pseudocode set the maximum value of m and n as l. In addition, the row- and column-dimensions of the register blocks (i.e., mblk and nblk) are set to be no greater than l. These requirements allow the vector mask to be applied for all iterations and eliminate the need for additional logic. The above pseudocode includes calls to the mask-creating function discussed previously to create register masks in both the row-dimension and the column-dimension, i.e., maskₘ and maskₙ, respectively. These created masks are applied to data operations (e.g., load, gather, and store). More specifically, the masks are applied as a bitwise AND operation to fill the unused lanes in the register with zeros such that the load or gather operation only collects data belonging to the input matrices from memory. Zero-filling unused vector lanes does not affect the results of arithmetic operations (e.g., vector addition), so masking is not needed for such instructions. The number of cycles needed to perform an operation does not depend on the number of active lanes (i.e., the number of unmasked lanes) because vector instructions operate on multiple data elements simultaneously.

The above pseudocode does not require m and n be multiples of l and includes all combinations of data orientations (N or T) for input matrices A and B. As discussed previously, when m and n are not multiples of l, the algorithm needs to check a number of extra cases {l, 2^{μ}, . . . , 2⁰} in the row- and column-dimensions, with each case requiring multiple conditional checks. The number of conditional checks is determined by traversing the list of cases in descending order for each term until the correct combination of cases with a sum equal to m or n is found. For example, for m or n=7=4+2+1, the algorithm would need to check the following combination of extra cases: {8, 4}+{8, 4, 2}+{8, 4, 2, 1}, requiring a total of 9 conditional checks. In another example, for m or n=5=4+1, the algorithm would need to check extra cases {8, 4}+{8, 4, 2, 1}, requiring a total of 6 conditional checks. The odd sizes (e.g., when m or n is an odd number) require all cases to be checked. Register masking may significantly reduce the number of checks needed, as one vector mask may be used to represent all cases. The algorithm only needs to create a suitable mask, which is equivalent to one conditional check.

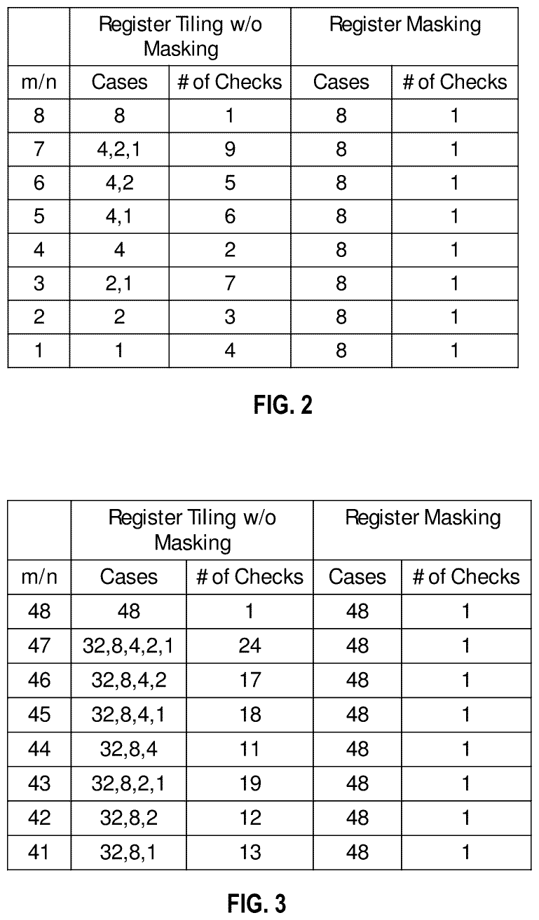

FIG. 2 illustrates a table comparing the number of conditional checks required by the conventional tiling technique without masking to the number of conditional checks required by the register masking technique, according to one aspect of the instant disclosure. As can be seen in FIG. 2, for input matrices with dimensions in the range [1, 8], the conventional tiling technique without masking requires checking four possible cases with an average of 1.63 cases and 4.63 checks across all sizes, whereas the register masking technique only needs to check one case and requires one check for all sizes. In some examples, the 8-bit register mask may include bit 0, bit 1, . . . , and bit 7. For a processor with a vector length l=8, the vector mask bits (denoted b) may be mapped to the sizes of the input matrices (denoted s) according to s=b+1.

In the examples shown in FIG. 1A and FIG. 1B, the configuration of the register tile is h×i=1×l, resulting in the dimensions of the tile in terms of matrix elements being l×l. In practice, depending on the dimensions of the input matrices and the number of available registers in the processor, the register tiles may have different configurations. In one example, the register tile configuration may be h×i=6×4, resulting in the dimensions of the tile in terms of matrix elements being 6*l×4=48×4. The cases (e.g., tile dimensions) to be considered in the row- and column-dimensions include m:{48, 32, 16, 8, 4, 2, 1} and n:{4, 2, 1}. With register masking, each case (in either the m- or n-dimension) of the tile size blkᵢ may be expanded to a set of sizes within the range [blkᵢ, . . . , blkᵢ−l). Accordingly, for the above register tile with a configuration of h×i=6×4, the considered cases may be expanded to m:{48, . . . , 41, 32, . . . , 25; 16, . . . 9, 8, . . . , 1} and n: {4, 2, 1}. Note that the cases considered in the n-dimension are not expanded, because n_{blk}=4<l.

One may further minimize the number of checks required for any given tile configuration and optimize the overall performance by including additional cases (other than the powers of 2), resulting in the complete set {blkₘₐₓ, . . . , 1}, where blkₘₐₓ refers to the dimension of the largest allowable tile. For example, if the m-dimension of the largest allowable tile is 48, one may want to check all cases ranging from 48 to 1. However, with register masking, only one check is needed for cases within the range [48, 47, . . . , 40), thus significantly reducing the number of checks. The complete set of cases may be described according to: ∃h≥1 [symbol] blkₘₐₓ=h*l and

$${{⋃}_{η = 1}}^{h} \{ η * l , … , ( ( η - 1 ) * l ) + 1 \} .$$

By definition, the relationship between consecutive masked cases is given by blkᵢ=i*l and blkᵢ−blkᵢ₋₁|=l for h≥i≥2. Therefore, the resulting set of cases required for the implementation may include {h*l, (h−1)*l, . . . , l}.

FIG. 3 illustrates a table comparing the number of conditional checks required by the conventional tiling technique without masking to the number of conditional checks required by the register masking technique, according to one aspect of the instant disclosure. In this example, the configuration of the register tile is h×i=6×4, the vector length is 8, resulting in the following to-be-checked cases: {48, 32, 16, 8, 4, 2, 1}, and the dimensions of the input matrices may be in the range [41, 48]. From the table, one can see that the conventional tiling technique without masking requires checking seven possible cases with an average of 3.38 cases and 14.38 checks across all sizes, whereas the register masking technique only needs to check one case and requires one check for all sizes.

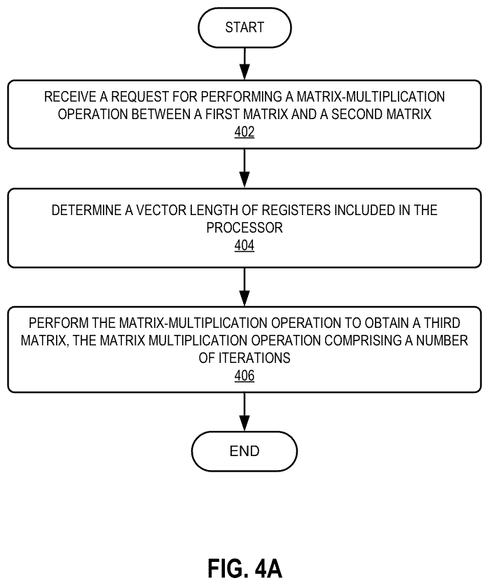

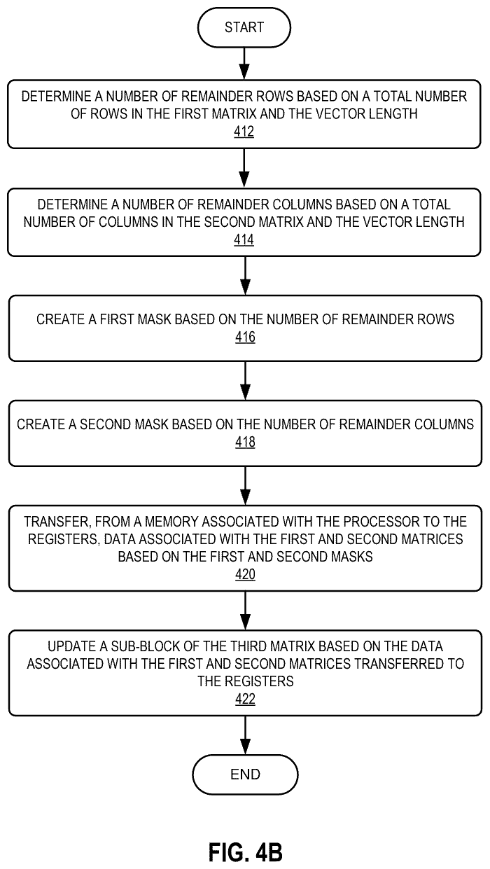

FIG. 4A presents a flowchart illustrating an example process for performing a matrix-multiplication operation, according to one aspect of the instant disclosure. All or any portion of the operations shown in FIG. 4A may be performed by a processor executing instructions. Although the example process in FIG. 4A shows a specific order for performing certain operations, the process is not limited to such an order. Operations shown in succession in the flowchart may be performed in a different order and may be executed concurrently or with partial concurrence or combinations thereof.

During operation, a processor may receive a request for performing a matrix-multiplication operation between a first matrix and a second matrix (operation 402). The two matrices may have arbitrary dimensions (e.g., rows and columns), given that the number of columns in the multiplier matrix (e.g., the first matrix) equals the number of rows in the multiplicand matrix (e.g., the second matrix). The processor may return an error message if such a condition is not met.

The processor may determine a vector length of registers included in the processor (operation 404). The vector length (denoted l) corresponds to the number of elements of the first or second matrix stored by a respective register. Note that the size of a register may depend on the type of processor (e.g., make and model) used for performing the matrix multiplication operation. Determining the vector length may involve dividing the size of the register by the data type size. In some examples, the processor may use 512-bit registers, and the data type of the matrix elements is 64-bit integer/floats, resulting in a vector length of eight.

The processor may then perform the matrix-multiplication operation to obtain a third matrix, the matrix-multiplication operation comprising a number of iterations (operation 406). The third matrix is the product matrix of the first and second matrices. The number of rows in the third matrix equals the number of rows in the first matrix, and the number of columns in the third matrix equals the number of columns in the second matrix. In some examples, the order of iteration may follow m/n/k loop ordering, where the outermost loop is in the row-dimension (i.e., the m-dimension), the middle loop is over the column-dimension (i.e., the n-dimension), and the innermost loop is in the k-dimension. Each m/n-loop defines a sub-block within the product matrix, and each k-loop updates the sub-block. Performing the matrix-multiplication operation comprises updating each sub-block of the product matrix a total of k times.

FIG. 4B presents a flowchart illustrating example operations within each iteration, according to one aspect of the instant disclosure. All or any portion of the operations shown in FIG. 4B may be performed by a processor executing instructions. Although the example process in FIG. 4B shows a specific order for performing certain operations, the process is not limited to such an order. Operations shown in succession in the flowchart may be performed in a different order and may be executed concurrently or with partial concurrence or combinations thereof.

During operation, the processor may determine a number of remainder rows based on the total number of rows in the first matrix and the vector length (operation 412). For a small matrix where m≤l, the number of remainder rows may be determined according to m mod l, where m corresponds to the number of rows in the first matrix, and l corresponds to the vector length. For cases where m is greater than l, the algorithm may first update sub-blocks that do not have remainder rows without applying the register mask until the m value is less than l.

The processor may further determine a number of remainder columns based on the total number of columns in the second matrix and the vector length (operation 414). For a small matrix where n≤l, the number of remainder columns may be determined according to n mod l, where n corresponds to the number of columns in the second matrix, and l corresponds to the vector length. For cases where n is greater than l, the algorithm may first update sub-blocks that do not have remainder columns without applying the register mask until the n value is less than l.

The processor may create a first mask based on the number of remainder rows (operation 416) and create a second mask based on the number of remainder columns (operation 418). Creating a respective mask may include initializing a mask with a length equal to the vector length and including all ones. For example, if the vector length is eight, the initialized mask may include eight ones. Creating the mask may also include determining a difference between the vector length and the number of remainder rows or columns and shifting the initialized mask with zeros based on the difference. In one example, there are seven remainder rows, and the difference between a vector length of eight and the seven remainder rows is one. Accordingly, the initialized mask may be shifted to the right by one bit and filled with a zero, generating the following mask [01111111]. If there are no remainder rows or columns, the initialized mask [11111111] will be used.

The processor may then transfer, from a memory associated with the processor to the registers, data associated with the first and second matrices based on the first and second masks, respectively (operation 420). According to some aspects, data associated with the first and second matrices are stored in the memory in a row-major or column-major order. Moreover, the data access pattern may be transposed or non-transposed. Transferring the data may include applying the first mask to transfer data associated with a first number of rows of the first matrix and applying the second mask to transfer data associated with a second number of columns of the second matrix. Applying the mask may involve a bitwise AND operation between the transferred data and the mask.

The processor may update a sub-block of the third matrix based on the data associated with the first and second matrices transferred to the registers (operation 422). The sub-block may have dimensions denoted as mblk×nblk, where 0≤mblk mod l<l and 0≤nblk mod l<l. According to some aspects, to update a sub-block of the third matrix, the processor performs vectorized dot product on the transferred data associated with the first and second matrices and accumulates the result. Within a particular mblk×nblk sub-block, the processor may determine the number of remainder rows by computing mblk mod l, where the remainder is in the range [0,l). Similarly, the processor may determine the number of remainder columns by computing nblk mod l, where the remainder is in the range [0,l). Regarding particular input matrices (e.g., the first and second matrices), the processor may also determine a row number (i.e., number of rows) corresponding to the sub-block and determine the number of remainder rows by dividing the total number in the first matrix over the row number. Similarly, the processor may determine a column number (i.e., the number of columns) corresponding to the sub-block and determine the number of remainder columns by dividing the total number of columns in the second matrix over the column number. The processor may repeat the iterations along the column- and row-dimensions until all sub-blocks (e.g., sub-block 110 shown in FIG. 1A or sub-block 130 shown in FIG. 1B) within the third matrix have been updated. As shown in FIG. 1B, most sub-blocks may be updated using an all-one mask because the remainder will be zero. Only the edge sub-blocks (e.g., the ones with remainder rows and columns) may require masks with zero bits.

The example pseudocode for performing matrix multiplication using register masking is shown below:

```
define mblkᵢ = [hₘ * l, (hₘ − 1) * l,...,l] for i = 1,...,x
define nblkⱼ = [hₙ * l, (hₙ − 1) * l,...,l] for j = 1,...,y
do {
  reset n
  create maskₘ
  n_loop:
  do {
    reset k
    create maskₙ
    duplicate mblkᵢ code for i = 1,...,x
    if m < mblkᵢ {
      jump mblkᵢ₊₁
    } else {
    mblk* = mblkᵢ
    duplicate nblkⱼ code for j = 1,...,y
    if n < nblkⱼ{
      jump nblkⱼ₊₁
    } else {
      while k > 0 {
        masked load + update
        C = AB (local)
        k = k − Δk
      }
      update C (global)
      n = n − nblkⱼ
      if j = 1 then jump n_loop
      }
    jump n_loop
    }
  } while n > 0
  m = m − mblk*
  } while m > 0
```

The first two lines of the above pseudocode define the row numbers and column numbers of a set of register tile configurations used in each loop, where hₘ and hₙ denote the configuration of the largest tile (also referred to as the base register tile) in the row- and column-dimension, respectively. The row and column numbers have been sorted in descending order. The row-dimension loop or the m_loop is the outermost loop, the column-dimension loop or the n_loop is the in-between loop, and the k_loop is the innermost loop with a step size of Ak. Data from matrices A and B are loaded using masked load/gather instructions in the k_loop, and the masks are generated in the outer m_loop and n_loop. According to some aspects, the above pseudocode may be implemented as a compute kernel for matrix multiplication. Compared with conventional approaches using the register tiling technique without masking, the proposed matrix-multiplication method reduces the number of required conditional checks, thus reducing the computation overhead.

In the above example, the register tiles have fixed sizes (i.e., the n-dimension values are fixed for all m-dimension values). In some examples, to enhance register utility, variable register tiles may be used, where the maximum n-dimension value may depend on the current m-dimension value. According to some aspects, for a given m-dimension value, the maximum n-dimension value may be determined based on the following constraint: f_{C}(h,i)+f_{A}(h)+f_{B}(i)≤N, where Nis the total number of registers provided by the processor, f_{C}(h,i) is the number of registers used to store elements from product matrix C, f_{A}(h) is the number of registers used to store elements from multiplier matrix A, and f_{B}(i) is the number of registers used to store elements from multiplicand matrix B. For the in-place/no-copy algorithm, the constraint may be expressed as h*i+h+min(2,i)≤N.

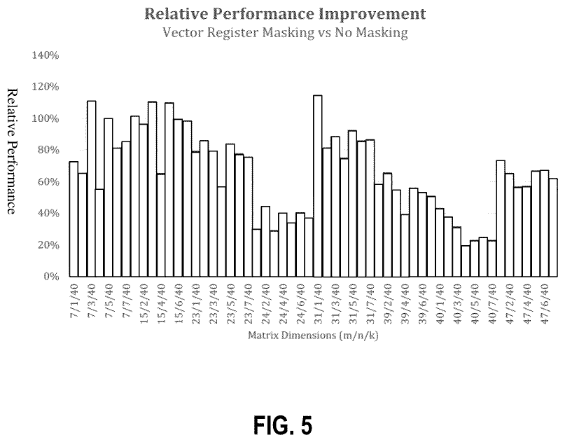

FIG. 5 illustrates the measured relative performance improvement of the register masking scheme over the conventional scheme without register masking, according to one aspect of the instant disclosure. In this example, the matrix-multiplication operation implements an in-place/no-copy scheme to load data from memory. The term “no-copy” means that the process does not make calls to external code to pack matrix data. The base register tile configuration is 6×4. The performance is measured in terms of the execution speed on an Intel Xeon Gold 6330 CPU for input matrices with various sizes. More specifically, the number of rows in matrix A may be selected from the set m:{7, 15, 23, 24, 31, 39, 40, 47}, the number of columns in matrix B may be selected from the set n:{1, 2, 3, 4, 5, 6, 7}, and k=40. As can be seen from FIG. 5, there is a significant gain in performance across input matrices of various sizes. In some cases (e.g., m=31, n=1, and k=40), the performance gain is above 100%. The average performance improvement across all tested matrix dimensions is 66.39%.

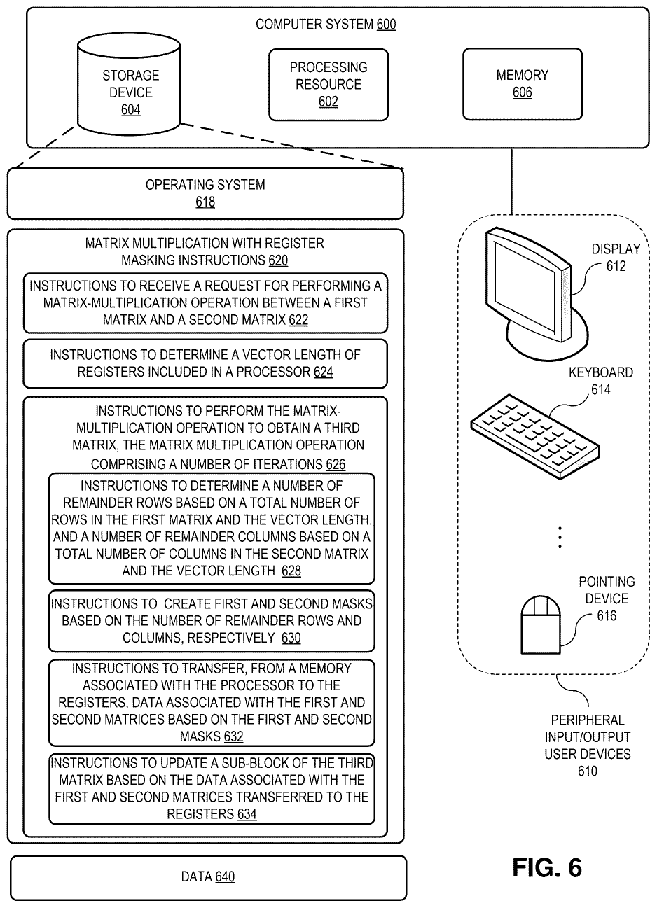

FIG. 6 illustrates an example computer system facilitating matrix multiplication with register masking, according to one aspect of the instant disclosure. Computer system 600 may include one or more processing resources (e.g., a processing resource 602), one or more storage devices (e.g., a storage device 604), and a memory 606. According to some aspects, processing resource 602 may include a number of registers (not shown in FIG. 6), such as floating-point registers, which may temporarily store data loaded from memory 606.

A processing resource may include, for example, one processor or multiple processors included in a single computing device or distributed across multiple computing devices. In some examples, the concurrent processes may be executed on a single computing device or multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Computer system 600 can be coupled to peripheral 1/O user devices 610 (e.g., a display device 612, a keyboard 614, and a pointing device 616). Storage device 604 includes a non-transitory computer-readable storage medium and stores an operating system 618, matrix-multiplication with register masking instructions 620, and data 640. Computer system 600 may include fewer or more entities than those shown in FIG. 6. According to some aspects, computer system 600 may be implemented by a standalone device or a compute node within a data center.

Matrix multiplication with register masking instructions 620 may include instructions, which when executed by computer system 600, can cause computer system 600 to perform methods and/or processes described in this disclosure. Matrix-multiplication with register masking instructions 620 can be executed at least on processing resource 602.

Matrix multiplication with register masking instructions 620 may include instructions 622 to receive a request for performing a matrix-multiplication operation between a first matrix and a second matrix, as described above in relation to operation 402 shown in FIG. 4A. The first matrix is often referred to as matrix A, and the second matrix is often referred to as matrix B. The matrix-multiplication operation may be part of a machine learning workflow. For example, in machine learning, features are often represented as matrices, which may be multiplied with weight matrices to transform a dataset into new representations.

Matrix multiplication with register masking instructions 620 may include instructions 624 to determine a vector length of registers included in a processor, as described above in relation to operation 404 shown in FIG. 4A. The processor may be part of processing resource 602. The vector length corresponds to a number of elements of the first or second matrix stored by a respective register.

Matrix multiplication with register masking instructions 620 may include instructions 626 to perform the matrix-multiplication operation to obtain a third matrix, as described above in relation to operation 406 shown in FIG. 4A. The matrix-multiplication operation may include a number of iterations.

Instructions 626 may further include instructions 628 to determine a number of remainder rows based on a total number of rows in the first matrix and the vector length, and a number of remainder columns based on a total number of columns in the second matrix and the vector length, as described above in relation to operations 412 and 414 shown in FIG. 4B. Register blocking or tiling may be used for matrix multiplication, where the product matrix (matrix C) may be divided into sub-blocks. Determining the number of remainder rows or columns may involve dividing the total number of rows in the first matrix or the number of columns in the second matrix over the row or column number of the sub-block. In one example, the number of remainder rows may be determined by dividing the total number of rows in the first matrix by the largest mblkᵢ value that satisfies the constraint mblkᵢ≤m, and the number of remainder columns may be determined by dividing the total number of columns in the second matrix by the largest nblkⱼ value that satisfies the constraint nblkⱼ≤n.

Instructions 626 may include instructions 630 to create first and second masks based on the number of remainder rows and columns, respectively, as described above in relation to operations 416 and 418 shown in FIG. 4B. The first mask is the row-dimension mask, whereas the second mask is the column-dimension mask. Each mask may be created by shifting and zero-filling a number of predetermined bits in an initial mask with all ones. The number of shifted bits equals the difference between the vector length and the number of remainder rows or columns.

Instructions 626 may include instructions 632 to transfer, from a memory associated with the processor to the registers, data associated with the first and second matrices based on the first and second masks, as described above in relation to operation 420 shown in FIG. 4B. The memory may be part of memory 606. Transferring the data may include a masked load or gather operation, depending on the layout of the input matrices in the memory.

Instructions 626 may include instructions 634 to update a sub-block of the third matrix based on the data associated with the first and second matrices transferred to the registers, as described above in relation to operation 422 shown in FIG. 4B. Updating the sub-block may include performing vectorized dot product on the transferred data associated with the first and second matrices and accumulating the result.

Matrix multiplication by register masking instructions 620 may include more instructions than those shown in FIG. 6. For example, matrix multiplication by register masking instructions 620 may include instructions to define a set of register tiles used for register blocking during the matrix-multiplication operation. In some examples, the set of register tiles may be fixed-sized tiles. In alternative examples, the set of register tiles may be variable-sized tiles, where the maximum column number of each tile depends on the row number of the tile.

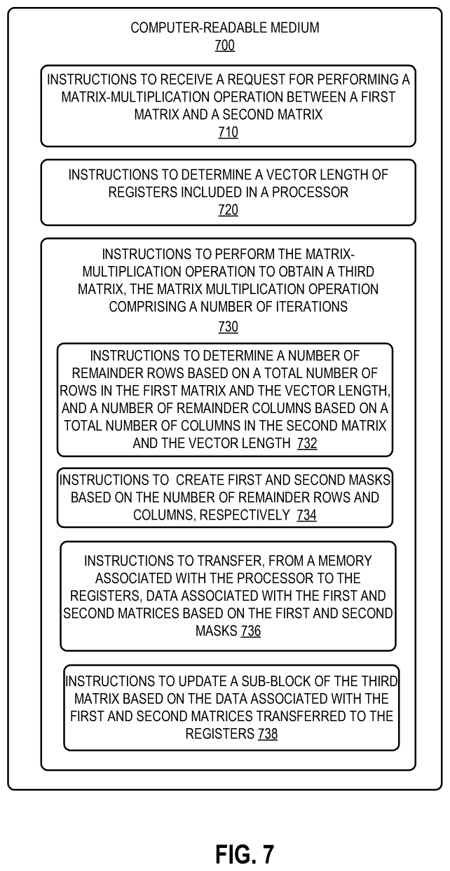

FIG. 7 illustrates a computer-readable medium (CRM) that facilitates matrix multiplication with register masking, according to one aspect of the instant disclosure. CRM 700 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 700 may store instructions 710 to receive a request for performing a matrix-multiplication operation between a first matrix and a second matrix, as described above in relation to operation 402 shown in FIG. 4A; instructions 720 to determine a vector length of registers included in a processor, as described above in relation to operation 404 shown in FIG. 4A; and instructions 730 to perform the matrix-multiplication operation to obtain a third matrix, as described above in relation to operation 406 shown in FIG. 4A.

Instructions 730 may further include instructions 732 to determine a number of remainder rows based on a total number of rows in the first matrix and the vector length, and a number of remainder columns based on a total number of columns in the second matrix and the vector length, as described above in relation to operations 412 and 414 shown in FIG. 4B; instructions 734 to create first and second masks based on the number of remainder rows and columns, respectively, as described above in relation to operations 416 and 418 shown in FIG. 4B; instructions 736 to transfer, from a memory associated with the processor to the registers, data associated with the first and second matrices based on the first and second masks, as described above in relation to operations 420 shown in FIG. 4B; and instructions 738 to update a sub-block of the third matrix based on the data associated with the first and second matrices transferred to the registers, as described above in relation to operations 422 shown in FIG. 4B.

CRM 700 may include more instructions than those shown in FIG. 7. For example, CRM 700 may include instructions to define a set of register tiles used for register blocking during the matrix-multiplication operation. In some examples, the set of register tiles may be fixed-sized tiles. In alternative examples, the set of register tiles may be variable-sized tiles, where the maximum column number of each tile depends on the row number of the tile.

In general, aspects of the disclosure provide a solution to improve the performance of matrix multiplication, especially for small matrices that are widely used in machine learning applications. More specifically, the disclosed system may use a register masking technique to deal with partial data loads and stores related to remainder rows and columns when register blocking is used for matrix-multiplication operations. A matrix-multiplication operation typically includes nested iterations. Within each iteration, the system may determine the number of remainder rows and columns to create row-dimension and column-dimension masks, respectively. The row-dimension mask may be used to transfer elements of the multiplier matrix, and the column-dimension mask may be used to transfer elements of the multiplicand matrix. Compared with conventional approaches that require separate conditionals for different remainder cases, the vector mask is flexible and can represent all remainder cases.

One aspect of the instant disclosure provides a system and method for improving the performance of matrix-multiplication operations. During operation, a processor may receive a request for performing a matrix-multiplication operation between a first matrix and a second matrix, determine a vector length of registers provided by the processor, the vector length corresponding to a number of elements of the first or second matrix stored by a respective register, and perform the matrix-multiplication operation to obtain a third matrix. The matrix-multiplication operation may include a number of iterations, each of which comprising: determining a number of remainder rows based on a total number of rows in the first matrix and the vector length; determining a number of remainder columns based on a total number of columns in the second matrix and the vector length; creating a first mask based on the number of remainder rows; creating a second mask based on the number of remainder columns; and transferring, from a memory associated with the processor to the registers, data associated with the first and second matrices based on the first and second masks, respectively.

In a variation on this aspect, transferring the data may include applying the first mask to transfer data associated with a first number of rows of the first matrix and applying the second mask to transfer data associated with a second number of columns of the second matrix.

In a further variation, applying the first or second mask may include initializing the first or second mask as including all ones, determining a difference between the vector length and the number of remainder rows or columns, and shifting the mask and filling shifted bits with zeros based on the difference.

In a variation on this aspect, data associated with the first and second matrices are stored in the memory in a row-major or column-major order, and transferring data associated with the first number of rows of the first matrix or the second number of columns of the second matrix may include accessing the to-be-transferred data in a transposed or non-transposed manner.

In a variation on this aspect, each iteration of the matrix-multiplication operation may further include updating a sub-block of the third matrix based on the data associated with the first and second matrices transferred to the registers, dimensions of the sub-block defined by a row number and a column number.

In a further variation, determining the number of remainder rows may include determining a row number corresponding to the sub-block and determining the number of remainder rows by dividing the total number of rows in the first matrix over the row number.

In a further variation, determining the number of remainder columns may include determining a column number corresponding to the sub-block and determining the number of remainder columns by dividing the total number of columns in the second matrix over the column number.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatuses. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method comprising:
receiving, at a processor, a request for performing a matrix-multiplication operation between a first matrix and a second matrix;
determining a vector length of registers provided by the processor, the vector length corresponding to a number of elements of the first or second matrix stored by a respective register; and
performing, by the processor, the matrix-multiplication operation to obtain a third matrix, the matrix-multiplication operation comprising a number of iterations, each of which comprising:
determining a number of remainder rows based on a total number of rows in the first matrix and the vector length;
determining a number of remainder columns based on a total number of columns in the second matrix and the vector length;
creating a first mask based on the number of remainder rows;
creating a second mask based on the number of remainder columns; and
transferring, from a memory associated with the processor to the registers, data associated with the first and second matrices based on the first and second masks, respectively.

2. The computer-implemented method of claim 1, wherein transferring the data comprises:
applying the first mask to transfer data associated with a first number of rows of the first matrix; and
applying the second mask to transfer data associated with a second number of columns of the second matrix.

3. The computer-implemented method of claim 2, wherein applying the first or second mask comprises:
initializing the first or second mask as including all ones;
determining a difference between the vector length and the number of remainder rows or columns; and
shifting the mask and filling shifted bits with zeros based on the difference.

4. The computer-implemented method of claim 1,
wherein data associated with the first and second matrices are stored in the memory in a row-major or column-major order; and
wherein transferring data associated with the first number of rows of the first matrix or the second number of columns of the second matrix comprises accessing the to-be-transferred data in a transposed or non-transposed manner.

5. The computer-implemented method of claim 1, wherein each iteration of the matrix-multiplication operation further comprises updating a sub-block of the third matrix based on the data associated with the first and second matrices transferred to the registers, dimensions of the sub-block defined by a row number and a column number.

6. The computer-implemented method of claim 5, wherein determining the number of remainder rows comprises:
determining a row number corresponding to the sub-block; and
determining the number of remainder rows by dividing the total number of rows in the first matrix over the row number.

7. The computer-implemented method of claim 5, wherein determining the number of remainder columns comprises:
determining a column number corresponding to the sub-block; and
determining the number of remainder columns by dividing the total number of columns in the second matrix over the column number.

8. A computer system, comprising:
at least one processor; and
a non-transitory computer-readable storage medium storing instructions that when executed by the processor cause the processor to perform a method, the method comprising:
receiving a request for performing a matrix-multiplication operation between a first matrix and a second matrix;
determining a vector length of registers provided by the processor, the vector length corresponding to a number of elements of the first or second matrix held by a respective register; and
performing the matrix-multiplication operation to obtain a third matrix, the matrix-multiplication operation comprising a number of iterations, each of which comprising:
determining a number of remainder rows based on a total number of rows in the first matrix and the vector length;
determining a number of remainder columns based on a total number of columns in the second matrix and the vector length;
creating a first mask based on the number of remainder rows;
creating a second mask based on the number of remainder columns; and
transferring, from a memory associated with the processor to the registers, data associated with the first and second matrices based on the first and second masks, respectively.

9. The computer system of claim 8, wherein transferring the data comprises:
applying the first mask to transfer data associated with a first number of rows of the first matrix; and
applying the second mask to transfer data associated with a second number of columns of the second matrix.

10. The computer system of claim 9, wherein applying the first or second mask comprises:
initializing the first or second mask as including all ones;
determining a difference between the vector length and the number of remainder rows or columns; and
shifting the mask and filling shifted bits with zeros based on the difference.

11. The computer system of claim 8,
wherein data associated with the first and second matrices are stored in the memory in a row-major or column-major order; and
wherein transferring data associated with the first number of rows of the first matrix or the second number of columns of the second matrix comprises accessing the to-be-transferred data in a transposed or non-transposed manner.

12. The computer system of claim 8, wherein each iteration of the matrix-multiplication operation further comprises updating a sub-block of the third matrix based on the data associated with the first and second matrices transferred to the registers, dimensions of the sub-block defined by a row number and a column number.

13. The computer system of claim 12, wherein determining the number of remainder rows comprises:
determining a row number corresponding to the sub-block; and
determining the number of remainder rows by dividing the total number of rows in the first matrix over the row number.

14. The computer system of claim 12, wherein determining the number of remainder columns comprises:
determining a column number corresponding to the sub-block; and
determining the number of remainder columns by dividing the total number of columns in the second matrix over the column number.

15. A non-transitory computer-readable storage medium storing instructions which when executed by a processor cause the processor to perform a method, the method comprising:
receiving, at the processor, a request for performing a matrix-multiplication operation between a first matrix and a second matrix;
determining a vector length of registers provided by the processor, the vector length corresponding to a number of elements of the first or second matrix held by a respective register; and
performing the matrix-multiplication operation to obtain a third matrix, the matrix-multiplication operation comprising a number of iterations, each of which comprising:
determining a number of remainder rows based on a total number of rows in the first matrix and the vector length;
determining a number of remainder columns based on a total number of columns in the second matrix and the vector length;
creating a first mask based on the number of remainder rows;
creating a second mask based on the number of remainder columns; and
transferring, from a memory associated with the processor to the registers, data associated with the first and second matrices based on the first and second masks, respectively.

16. The non-transitory computer-readable storage medium of claim 15, wherein transferring the data comprises:
applying the first mask to transfer data associated with a first number of rows of the first matrix; and
applying the second mask to transfer data associated with a second number of columns of the second matrix.

17. The non-transitory computer-readable storage medium of claim 16, wherein applying the first or second mask comprises:
initializing the first or second mask as including all ones;
determining a difference between the vector length and the number of remainder rows or columns; and
shifting the mask and filling shifted bits with zeros based on the difference.

18. The non-transitory computer-readable storage medium of claim 15,
wherein data associated with the first and second matrices are stored in the memory in a row-major or column-major order; and
wherein transferring data associated with the first number of rows of the first matrix or the second number of columns of the second matrix comprises accessing the to-be-transferred data in a transposed or non-transposed manner.

19. The non-transitory computer-readable storage medium of claim 15, wherein each iteration of the matrix-multiplication operation further comprises updating a sub-block of the third matrix based on the data associated with the first and second matrices transferred to the registers, dimensions of the sub-block defined by a row number and a column number.

20. The non-transitory computer-readable storage medium of claim 19,
wherein determining the number of remainder rows comprises:
determining a row number corresponding to the sub-block; and
determining the number of remainder rows by dividing the total number of rows in the first matrix over the row number; and
wherein determining the number of remainder columns comprises:
determining a column number corresponding to the sub-block; and
determining the number of remainder columns by dividing the total number of columns in the second matrix over the column number.
